(19) United States
(12) Patent Application Publication
(10) Pub. No.: US 2026/0062262 A1
(43) Pub. Date: Mar. 5, 2026

(54) Winch Assembly and Method of Manufacture

(71) Applicant: Marmon Power Systems, Inc., Fairview, TN (US)

(72) Inventor: Matthew QUINN, Fairview, TN (US)

(73) Assignee: Marmon Power Systems, Inc., Fairview, TN (US)

(21) Appl. No.: 19/311,875

(22) Filed: Aug. 27, 2025

Related U.S. Application Data
(60) Provisional application No. 63/688,171, filed on Aug. 28, 2024.

(51) Int. Cl. B66D 1/06; B66D 1/22

(52) U.S. Cl. CPC B66D 1/06; B66D 1/22

(57) ABSTRACT

A winch assembly and method of manufacturing the assembly is provided. The winch assembly includes a drive assembly with a pinion gear and drive gear, the pinion is coupled to a drive axle rotatably coupled to a crank arm for rotating the pinion gear, and the drive gear. The winch assembly includes a spool assembly comprising a spool axle rotatably coupled to the drive gear. The spool axle includes first and second ratchet walls for supporting a pulling member during use. The winch assembly includes a locking assembly comprising a locking gear that is rotatably coupled to the drive axle. The locking assembly further comprises a lever, a cam wherein the lever is rotatably coupled to the cam, and first and second pawls.

### RELATED APPLICATIONS

This application claims priority to U.S. Provisional Ser. No. 63/688,171 filed Aug. 28, 2024, the content of which is hereby incorporated herein by reference in its entirety.

### FIELD OF THE DISCLOSURE

The present disclosure generally relates to a winch assembly and method of manufacturing the same, more particularly, a manual winch assembly for attaching and facilitating the movement of a large object such as a boat, automobile, and the like in a desired direction.

### BACKGROUND OF THE INVENTION

Towing trailers are designed and configured to transport large objects, including, but not limited to, boats, cars, housing units, recreational vehicles, trailers, machinery, and equipment. In order to move such large objects onto and from the towing trailers, winch assemblies are known to facilitate the onboarding and offboarding of the large objects. For example, winch assemblies for such purposes are shown and described in U.S. Pat. Nos. 9,206,022 and 8,459,615. The aforementioned patents are incorporated herein by reference in their entireties for all purposes.

Conventional winch assemblies shown and described in the '022 and '615 patents are typically attached to a hauling or towing trailer and a strap from the assembly is attached to the object and used to pull the object onto the towing trailer during a loading operation. The winch assembly is also used to unload the object by releasing the strap during an unloading operation.

### SUMMARY OF THE INVENTION

One aspect of the present disclosure which includes a winch assembly and method of manufacturing the assembly is provided. The winch assembly includes a drive assembly with a pinion gear and drive gear, the pinion is coupled to a drive axle rotatably coupled to a crank arm for rotating the pinion gear, and the drive gear. The winch assembly includes a spool assembly comprising a spool axle rotatably coupled to the drive gear. The spool axle includes first and second ratchet walls for supporting a tow strap during use. The winch assembly includes a locking assembly comprising a locking gear that is rotatably coupled to the drive axle. The locking assembly further comprises a lever, a cam wherein the lever is rotatably coupled to the cam, and first and second pawls.

Another aspect of the present disclosure which includes a winch assembly and method of manufacturing the assembly is provided. The winch assembly includes a drive assembly with a pinion gear and drive gear, the pinion is coupled to a drive axle rotatably coupled to a crank arm for rotating the pinion gear, and the drive gear. The winch assembly includes a spool assembly comprising a spool axle rotatably coupled to the drive gear. The spool axle includes first and second ratchet walls for supporting a pulling member 18, such as a tow strap, chain, rope, and/or cable during use. The winch assembly includes a locking assembly comprising a locking gear that is rotatably coupled to the drive axle. The locking assembly further comprises a lever, a cam wherein the lever is rotatably coupled to the cam, and first and second pawls, such that rotation of the lever rotates the cam to a first position so that the first pawl limits the rotation of the drive axle and spool axle to a forward rotation.

While another aspect of the present disclosure includes a winch assembly comprising a drive assembly having a pinion gear and drive gear such that the pinion is coupled to a drive axle rotatably coupled to a crank arm for rotating the pinion gear, and the drive gear; a spool assembly comprising a spool axle rotatably coupled to the drive gear, the spool axle having first and second ratchet walls for supporting a pulling member during use; and a locking assembly comprising a locking gear that is rotatably coupled to the drive axle, the locking assembly further comprising a lever, a cam wherein the lever is rotatably coupled to the cam, and first and second pawls, such that rotation of the lever rotates the cam to a first position so that the first pawl limits the rotation of the drive axle and spool axle to a forward rotation, wherein the first and second pawls each comprise a first contact and a second contact for engaging and locking multiple teeth on the locking gear.

A further aspect of the present disclosure provides a winch assembly comprises a drive assembly having a pinion gear and drive gear such that the pinion is coupled to a drive axle rotatably coupled to a crank arm for rotating the pinion gear, and the drive gear; a spool assembly comprising a spool axle rotatably coupled to the drive gear, the spool axle having first and second ratchet walls for supporting a pulling member during use; and a locking assembly comprising a locking gear that is rotatably coupled to the drive axle, the locking assembly further comprising a lever, a cam wherein the lever is rotatably coupled to the cam, and first and second pawls, such that rotation of the lever rotates the cam to a first position so that the first pawl limits the rotation of the drive axle and spool axle to a forward rotation, wherein the cam further comprises a lubrication port for lubricating an interface between the cam the first and second pawls.

Another aspect of the present disclosure includes a winch assembly comprising a drive assembly having a pinion gear and drive gear such that the pinion is coupled to a drive axle rotatably coupled to a crank arm for rotating the pinion gear, and the drive gear; a spool assembly comprising a spool axle rotatably coupled to the drive gear, the spool axle having first and second ratchet walls for supporting a pulling member during use; and a locking assembly comprising a locking gear that is rotatably coupled to the drive axle, the locking assembly further comprising a cam rotatably engaging first and second pawls, wherein the first and second pawls are rotatably biased toward the locking gear by a biasing member.

While another aspect of the present disclosure includes a winch assembly comprising a housing having a first side and second side for supporting a drive assembly therein; the drive assembly having a pinion gear and drive gear such that the pinion is coupled to a drive axle rotatably coupled to a crank arm for rotating the pinion gear, and the drive gear; a spool assembly comprising a spool axle rotatably coupled to the drive gear, the spool axle for securing a pulling member during use; a locking assembly comprising a locking gear that is rotatably coupled to the drive axle; and a frame assembly comprising first and second walls spaced by a base plate, the frame assembly for supporting the drive axle and the spool axle within the housing.

These and other objects, functions, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a first perspective view of an example winch assembly, according to one or more aspects described herein;

FIG. 2 depicts another perspective view of an example winch assembly, according to one or more aspects described herein;

FIG. 3 depicts another perspective view of an example winch assembly, according to one or more aspects described herein;

FIG. 4 depicts another perspective view of an example winch assembly, according to one or more aspects described herein;

FIG. 5 depicts a front elevation view of an example winch assembly, according to one or more aspects described herein;

FIG. 6 depicts a rear elevation view of an example winch assembly, according to one or more aspects described herein;

FIG. 7 depicts a top plan view of an example winch assembly, according to one or more aspects described herein;

FIG. 8 depicts a bottom plan view of an example winch assembly, according to one or more aspects described herein;

FIG. 9 depicts a right-side elevation view of an example winch assembly, according to one or more aspects described herein;

FIG. 10 depicts a left-side elevation view of an example winch assembly, according to one or more aspects described herein;

FIG. 11 depicts an exploded assembly view of an example winch assembly, according to one or more aspects described herein;

FIGS. 12-21 depict various views of an example drive arrangement for a winch assembly, according to one or more aspects described herein;

FIGS. 22-38 are various views of internal, external, magnified, assembly, and cross-section views of an example winch assembly in accordance with an example embodiment;

FIG. 39 depicts a perspective view of an example lubricating cam shaft, according to one or more aspects described herein;

FIGS. 40-45 depict an operation assembly of an example winch assembly in different operating positions in accordance with example embodiments described and depicted herein;

FIG. 46 illustrates a cross-section view of an example operation assembly in accordance with one example embodiment of the present disclosure; and

FIG. 47 depicts a perspective view of an example pawl of the operation assembly described herein including a chamfered portion around a catch, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. These aspects are indicative, however, of but a few of the various ways in which the principles of the invention may be employed and the present invention is intended to include all such aspects and their equivalents. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example functions and elements of the invention, these terms are used herein as a matter of convenience, e.g., based on the example orientations shown in the figures. Nothing in this specification should be construed as requiring a specific three-dimensional orientation of structures in order to fall within the scope of this invention.

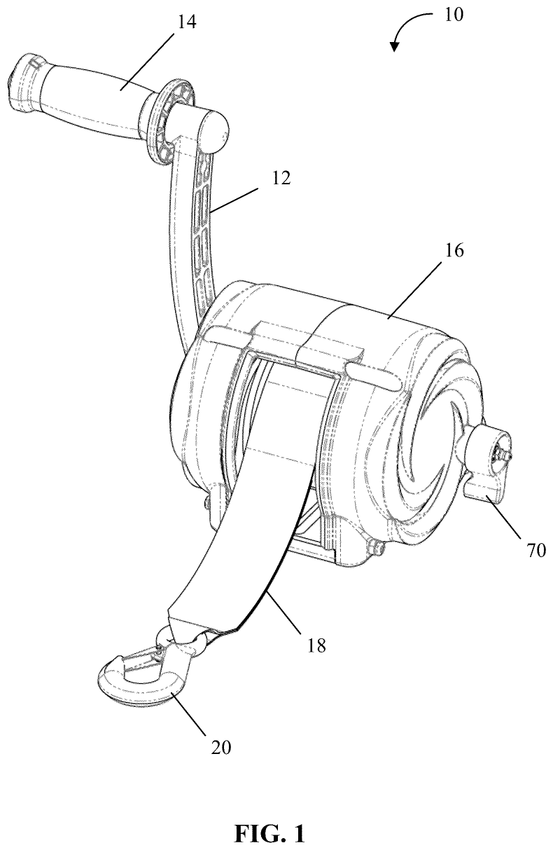

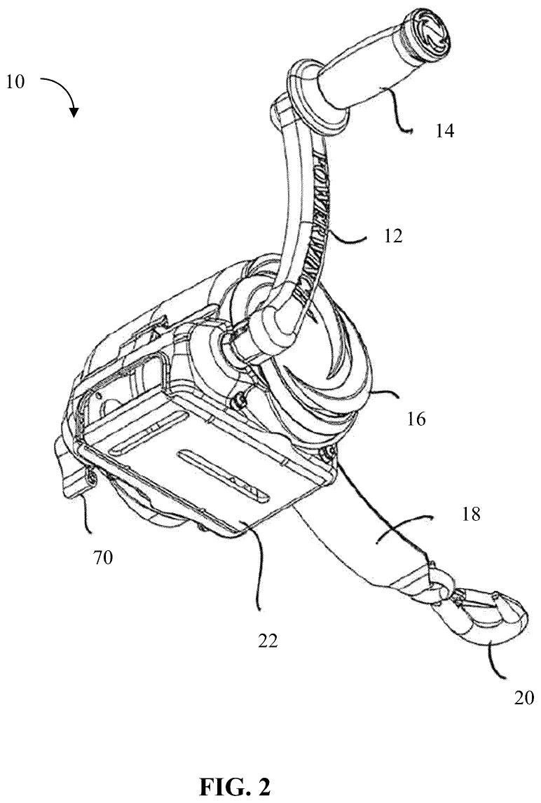

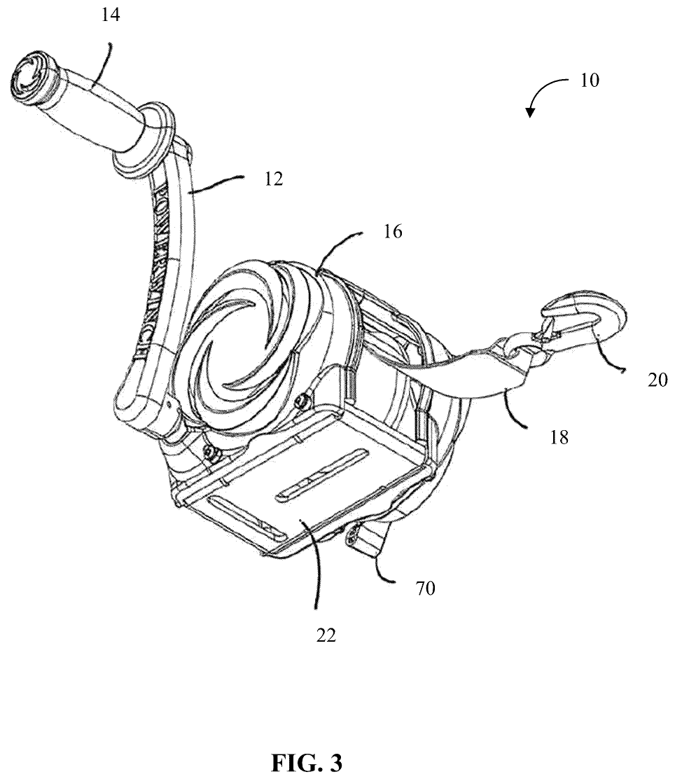

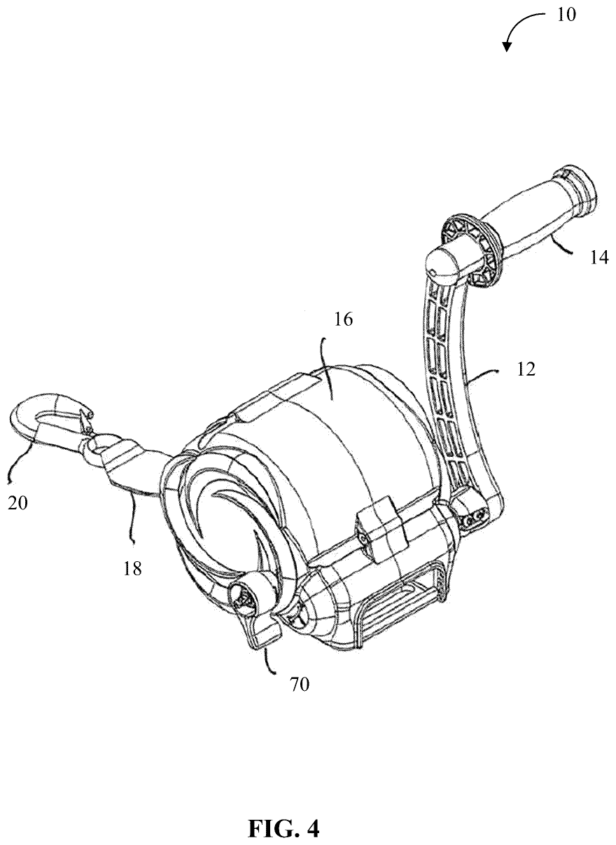

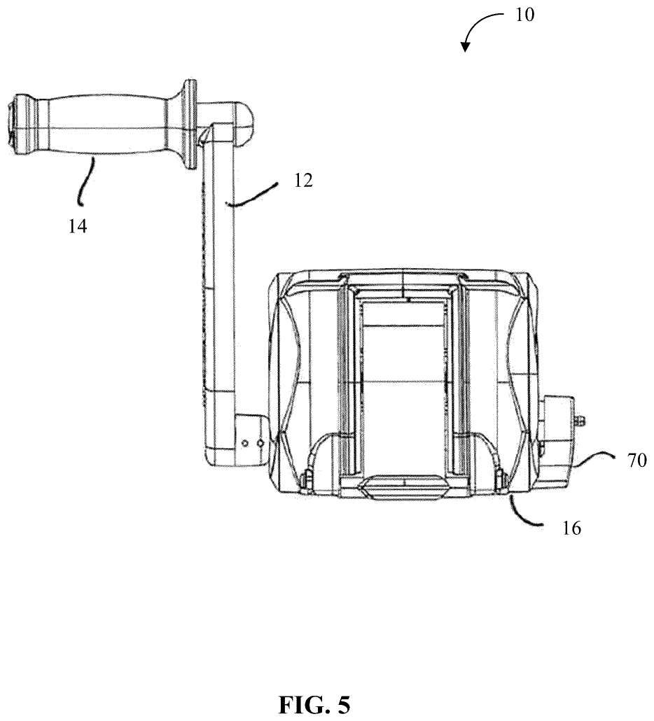

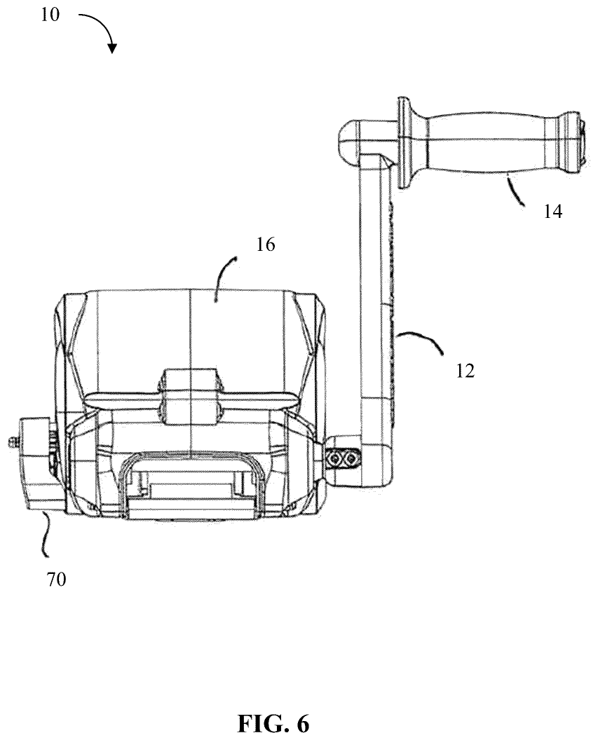

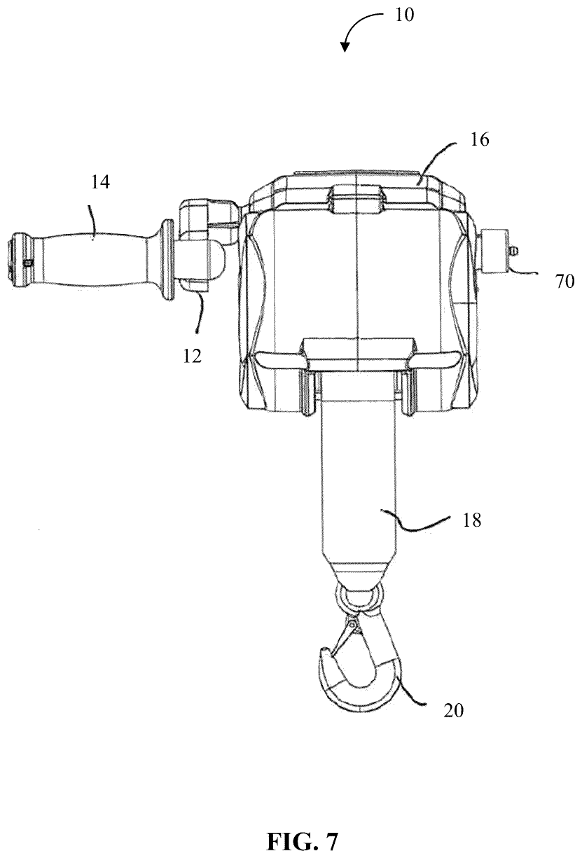

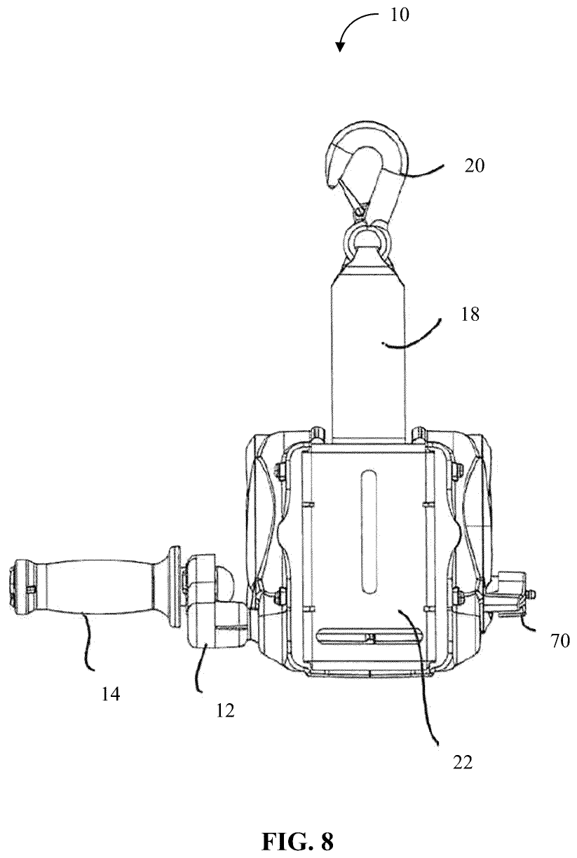

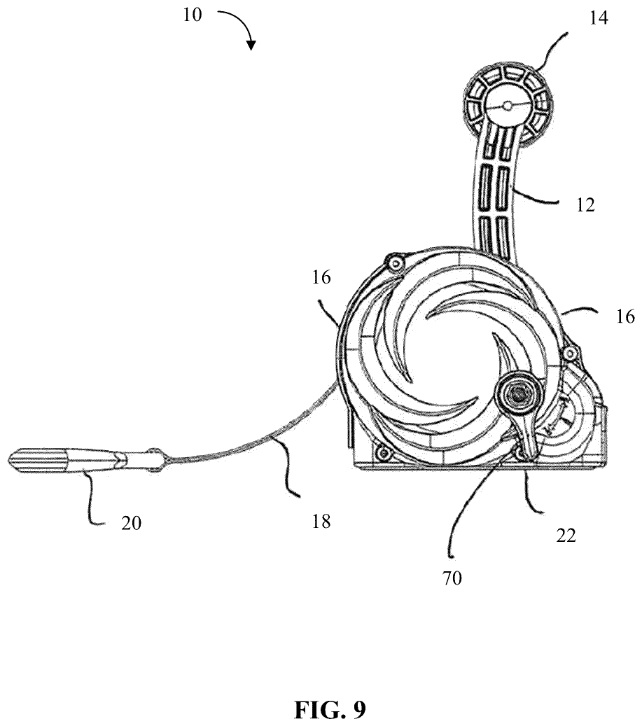

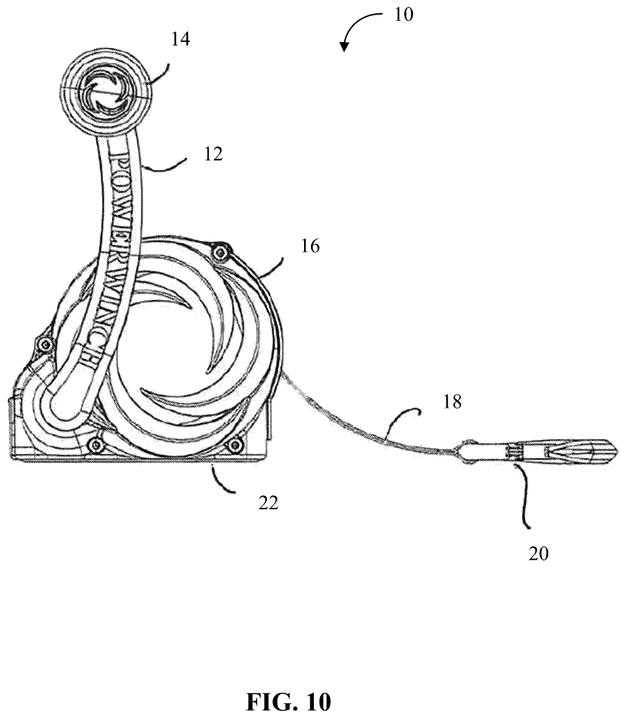

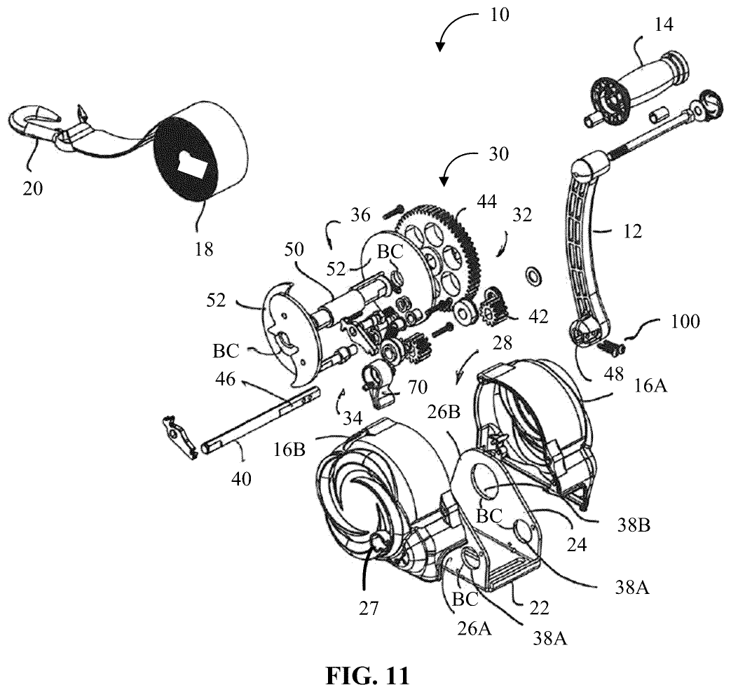

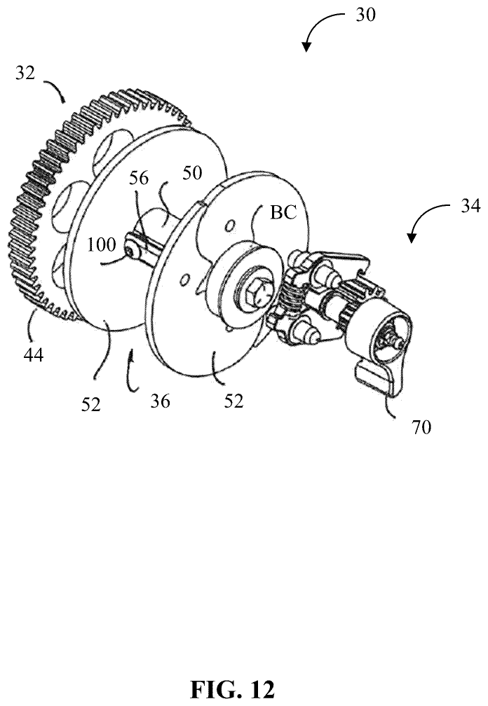

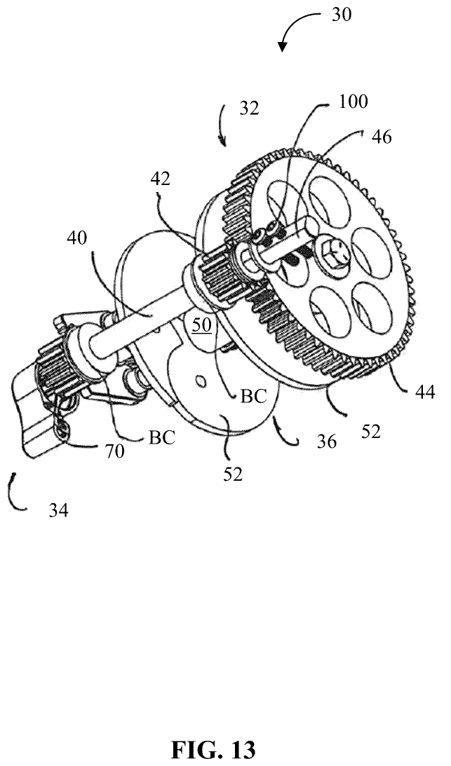

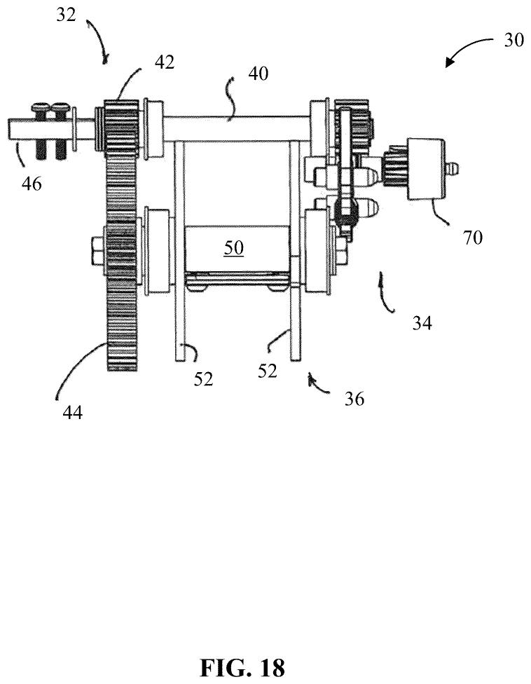

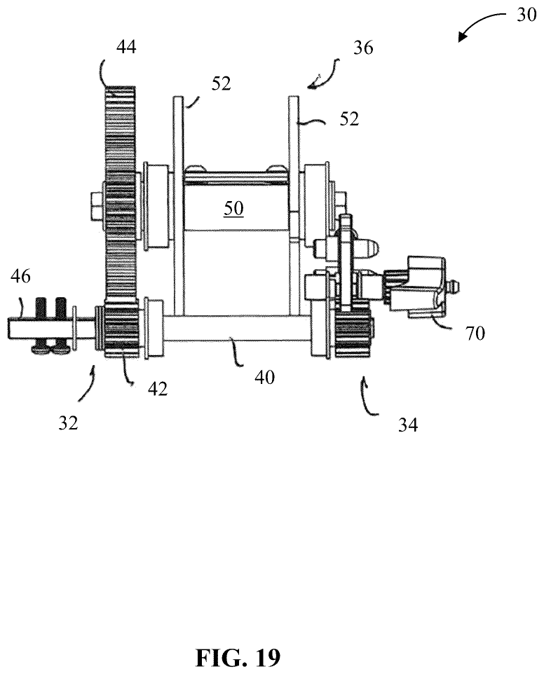

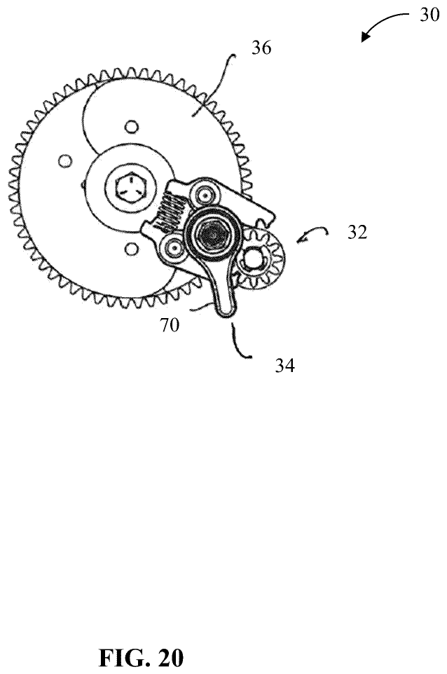

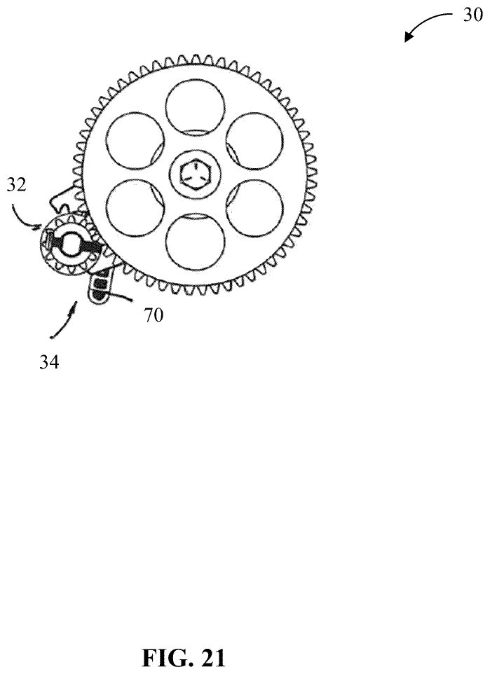

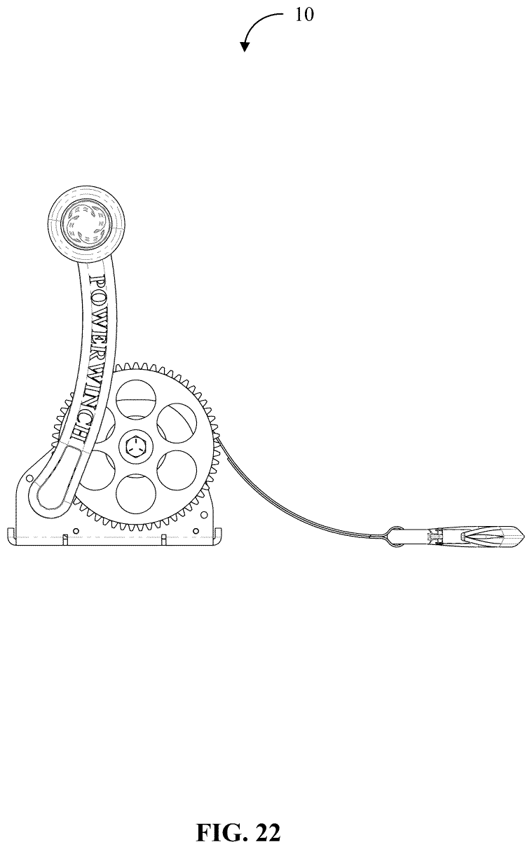

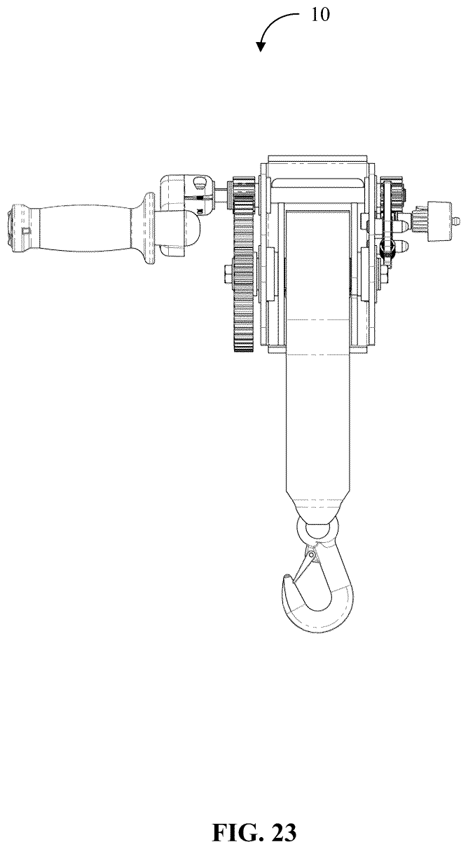

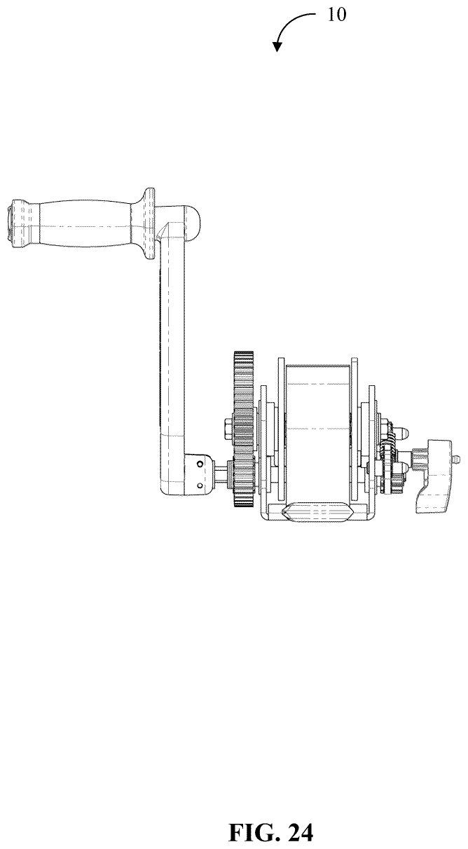

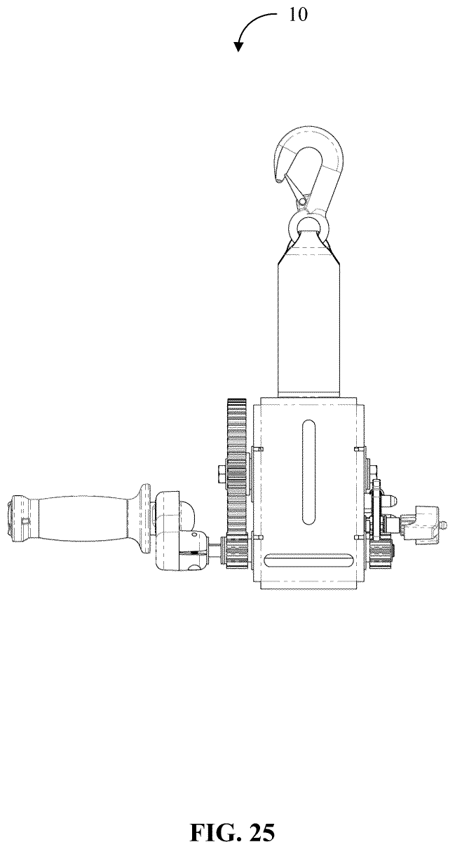

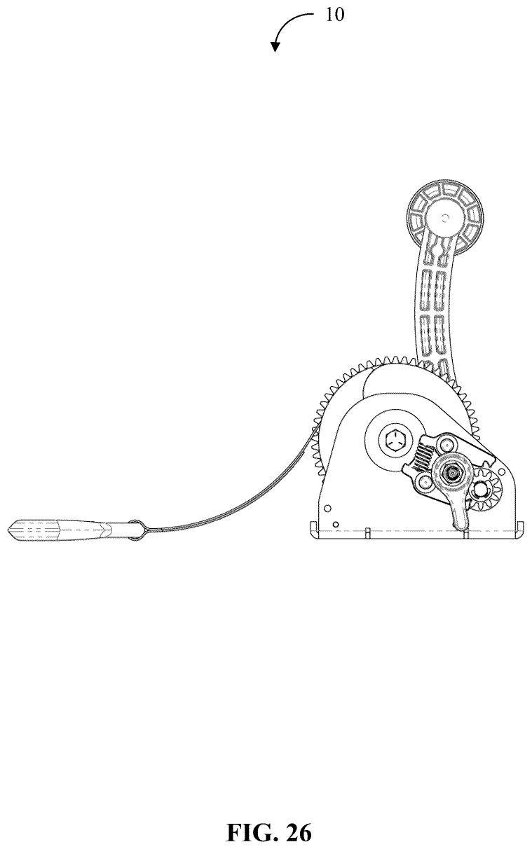

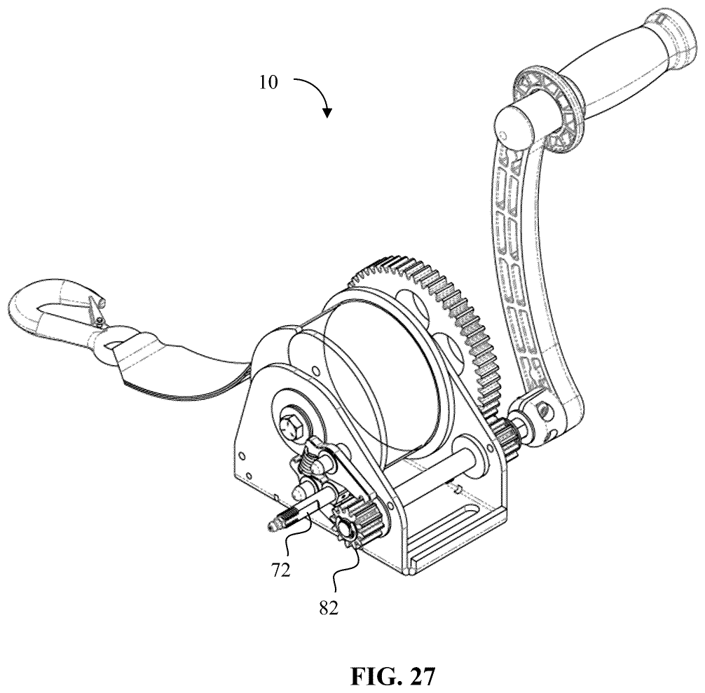

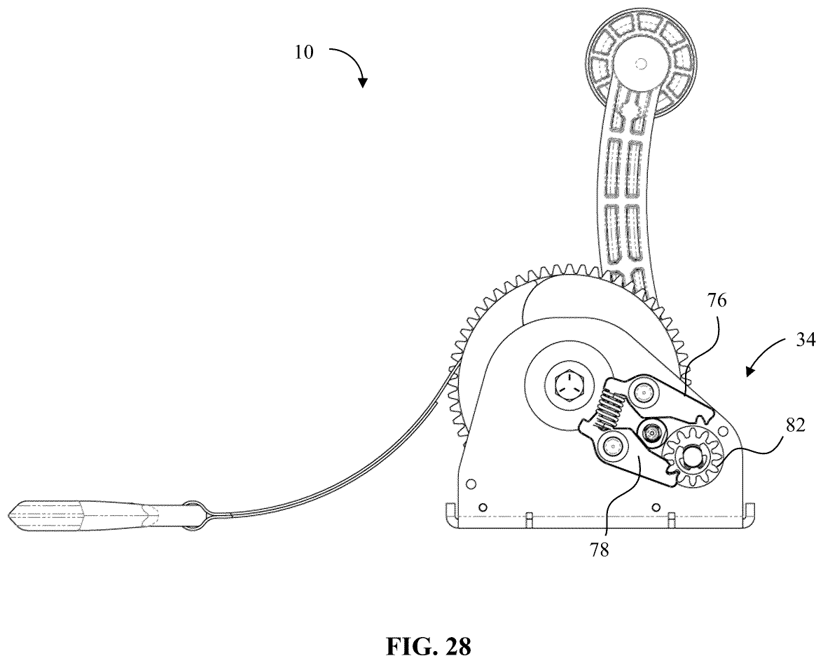

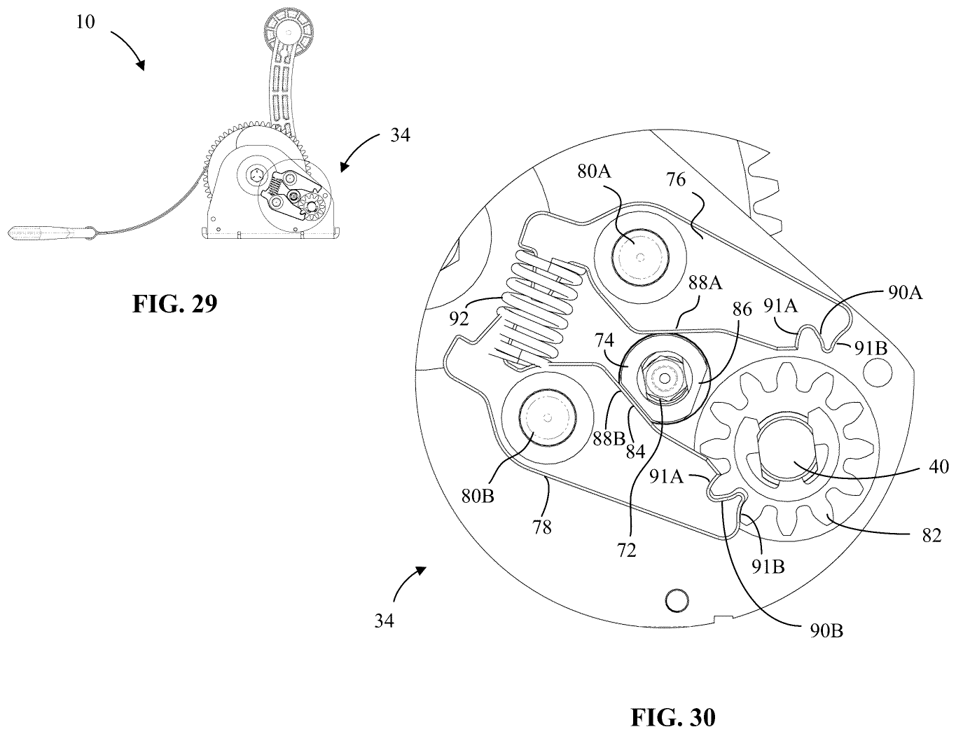

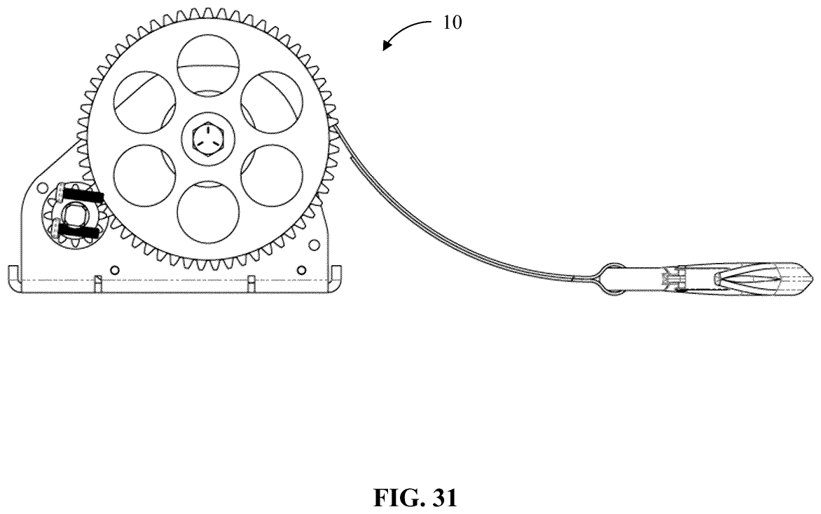

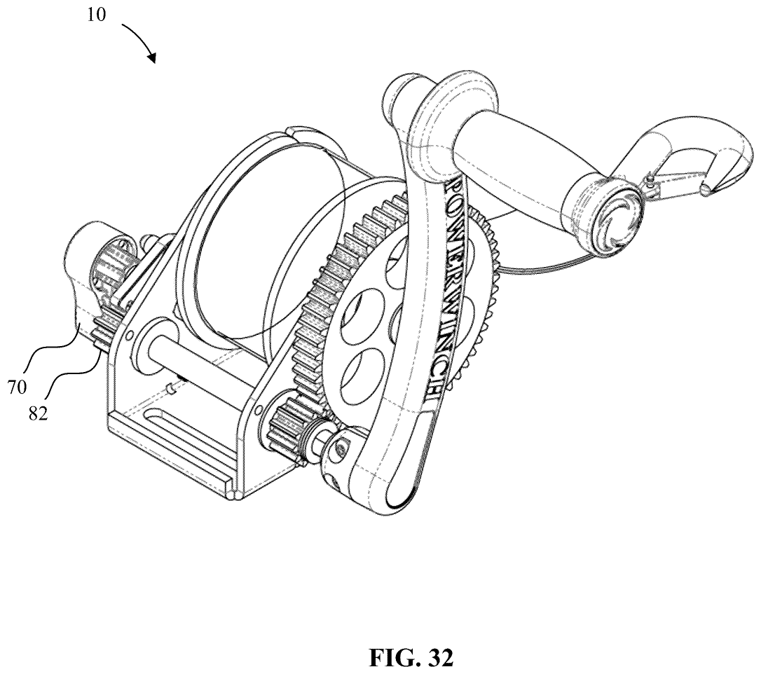

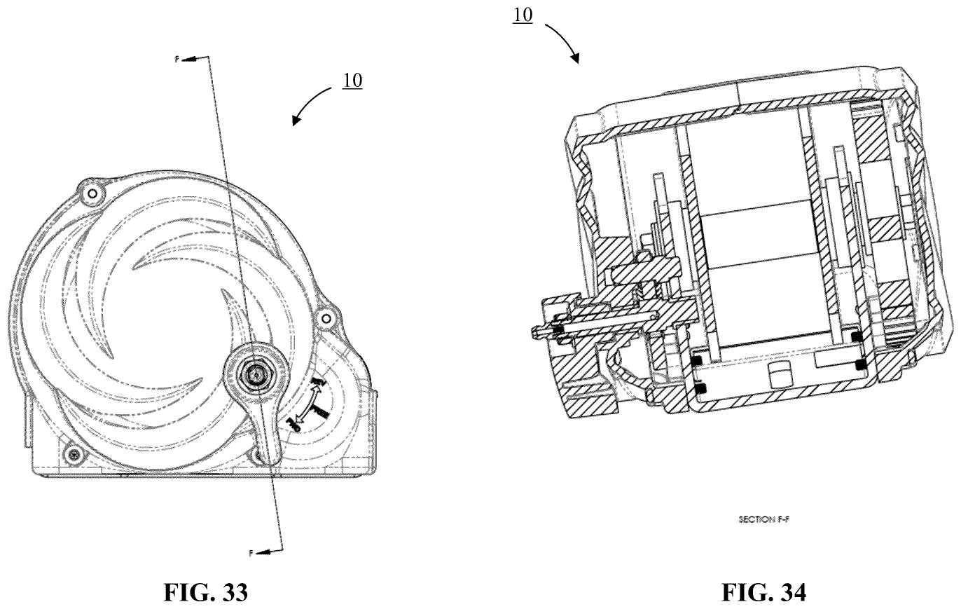

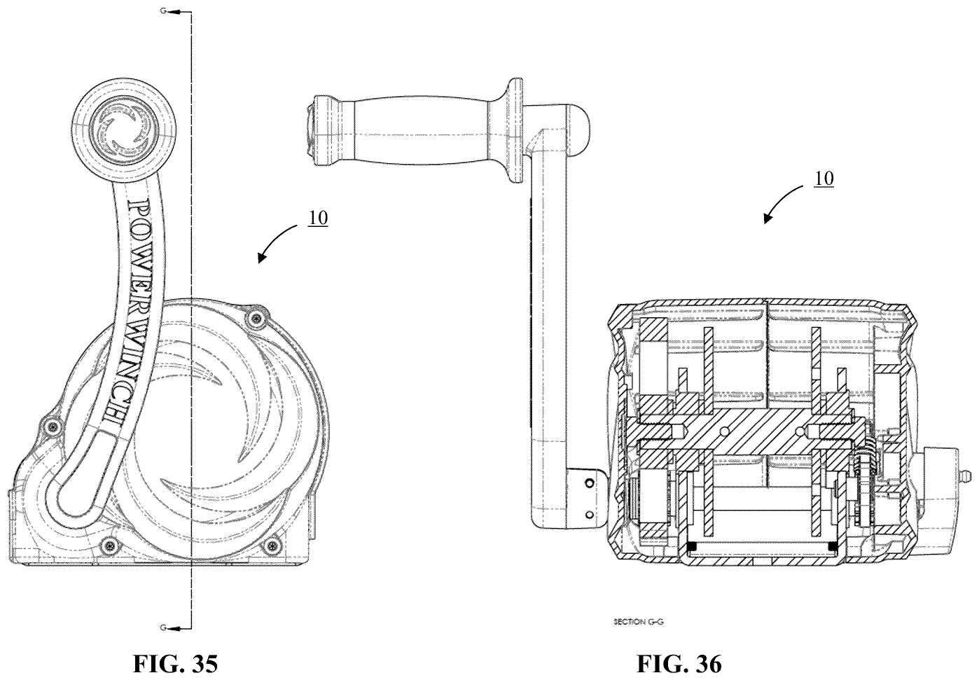

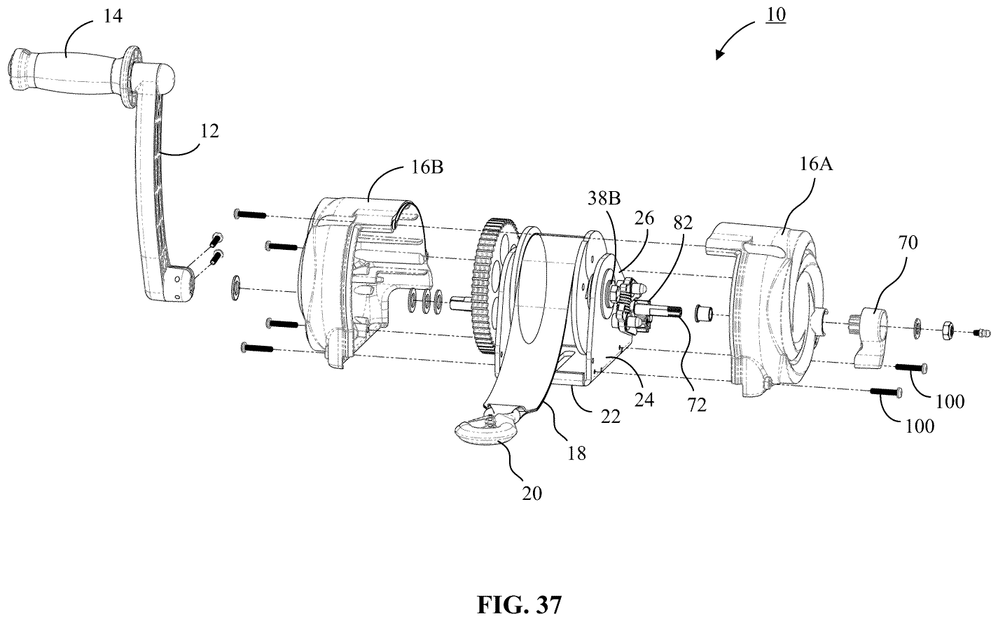

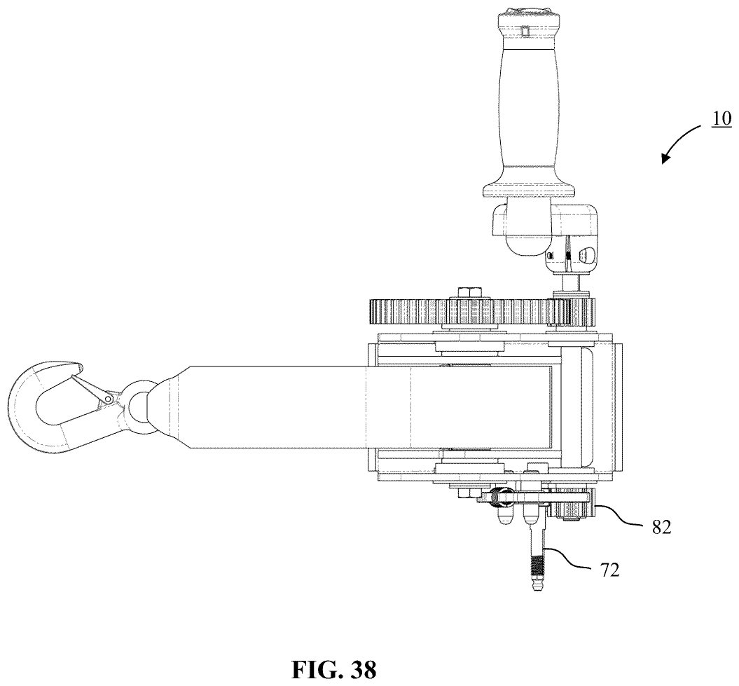

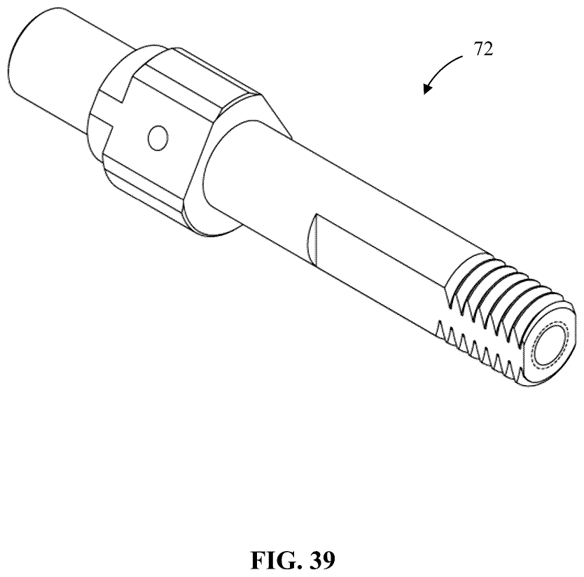

The invention described herein relates to a winch assembly 10 and method of manufacturing the same and, more particularly, a manual winch assembly for attaching and facilitating the movement of a large object such as a boat, automobile, and the like in a desired direction. Illustrated in FIGS. 1-10 are various views of a winch assembly 10 constructed in accordance with one example embodiment of the present disclosure. In various embodiments, winch assembly 10 may comprise a crank arm 12, handle 14, housing 16, pulling member 18, latch 20, and base plate 22. As illustrated in the exploded assembly view of FIG. 11, the winch assembly 10 may further comprise a drive arrangement 30 that is made up of a drive assembly 32, operation assembly 34, and spool assembly 36. FIGS. 12-21 illustrate additional views of the drive arrangement constructed in accordance with one example embodiment of the present disclosure. FIGS. 22-38 are various views of internal, external, magnified, assembly, and cross-section views of the winch assembly in accordance with one example embodiment.

The winch assembly in one example embodiment is attached to a towing trailer in which large objects (such as boats, cars, housing units, recreational vehicles, trailers, machinery, dunnage, packages, bins, containers, and equipment, hereinafter “large objects”) are drawn on and off of the trailer with the assistance and operation of the winch assembly 10. In another example embodiment, the winch assembly 10 is attached to a static fixture such as a loading dock, wall, beam, column, and/or ceiling and used to raise, lower, advance, and/or retract large objects in a selectively desired direction. In another example embodiment, the winch assembly 10 is attached to a boat or truck so that the boat or truck can be pulled to a particular direction or object.

Returning to FIG. 11, the housing 16 includes both first 16A and second 16B sides that are secured together by fasteners 100. Within the housing is a cavity 28 that encloses a frame 24 and a large portion of the drive arrangement 30. The frame 24 supports the operation of the drive arrangement 30 and includes the base plate 22 that spaces first and second side walls 26A and 26B.

The drive arrangement 30 includes a drive assembly 32, operation assembly 34, and spool assembly 36. The drive assembly 32 is coupled to the crank arm 12 and handle 14 that are manually rotated to draw the pulling member 18 and large objects connected thereto by the latch 20 to a desired location. As the crank arm 12 is rotated, the drive assembly 32 is rotated thereby rotating the spool assembly 34 in a controlled advance of the large object such that the pulling member 18 is coiled onto the spool assembly 36. The drive assembly 32 is also used to provide a controlled release of a large object by unlocking the pulling member 18 by adjusting the operation assembly 34 to reverse the drive assembly 32 and spool assembly 36.

At the end and coupled to the pulling member 18 is a latch 20 that is used to attached to large objects to be maneuvered by the winch assembly. The latch 20 includes spring clasp and hook arrangement, but it should be appreciated by those skilled in the art with the advantage of reviewing this specification and associated drawings that other types of latches could be used without departing from the spirit and scope of the present disclosure.

The sidewalls 26 of the frame 24 include first and second axle apertures 38A, 38B. The apertures 38 provide support to the drive assembly 32, operation assembly 34, and spool assembly 36. In FIGS. 11 and 13-19, the drive assembly 32 is illustrated and comprises a drive axle 40 with a pinion gear 42 coupled thereon by a press-fit connection, slot and key combination, slip-fit connection, set-screw, and the like. The drive assembly further comprises a drive gear 44 that is engaged and driven by the rotation of the pinion gear 42.

The drive axle 40 includes a flat 46 machined along one end that is tapped with two fasteners 100. The flat 46 is inserted into a mating aperture 48 broached or molded into the crank arm 12. The flat 46 aperture 48 square-like configuration provides advantageously an anti-rotation slip between the axle 40 and the arm 12. The arm 12 is then further secured to the axle 40 by fasteners 100. As the arm 12 is rotated, the axle 40 is rotated in the same direction, thereby rotating the pinion 42 in the same direction. The pinion 42 teeth rotationally engage the teeth of the drive gear 44, rotating the drive gear in an opposite direction.

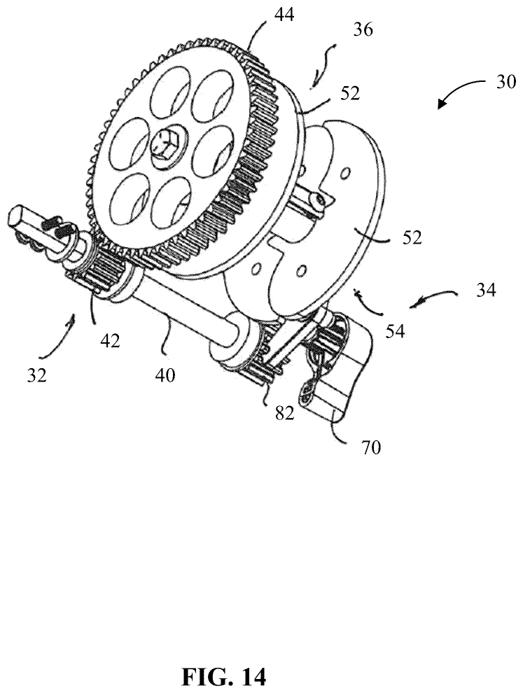

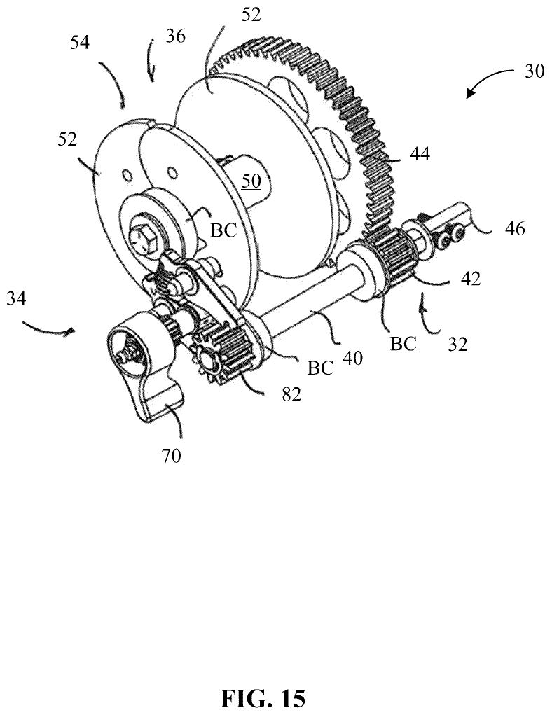

The drive gear 44 is coupled to a spool axle 50 of the spool assembly 36. The spool assembly 36 further comprises first and second ratchet walls 52, rotatably coupled to and spaced by the spool axle 50. The ratchet walls 52 are designed and configured to include fixture profiles 54 (as depicted, for example, in FIGS. 14 and 15) for coiling and uncoiling the pulling member 18 depending on the direction of rotation of the spool axle 50, drive gear 44, pinion 42, drive axial 40, and handle/crank 12, 14 that all operate in concomitant rotation although in opposite directions relative to the drive axle and spool axle.

The pulling member 18 includes a first end that is coupled to a latch 20, whilst a second end of the pulling member is fixedly attached to a plate 56 fastened along the spool axle 50 as illustrated in FIG. 12. The fastener(s) 100 are removed from the spool axle 50 that passes through the plate 56 so that the second end of the pulling member 18 is in contact with the axle. The plate is then placed on top of the pulling member and secured in place by fastener(s) 100. As such, the pulling member 18 is rotatably fixed to the spool axle 50 and rotates in a first direction for coiling and a second direction opposite the first direction for uncoiling.

Extending along the drive axle 40 at an end opposite the drive assembly 32 is the operation assembly 34. The operation assembly 34 (as depicted, for example, in FIGS. 12-13, 15-19 and 30) comprises a lever 70 rotatably fixed to a cam shaft 72, a cam 74, first and second pawls, 76, 78 that are supported by pawl shafts 80A, 808, and locking gear 82. The locking gear 82 is rotatably coupled to the drive axle 40.

The operation assembly 34 controls the rotation of the winch assembly 10 and retraction/extraction of the pulling member through the lever 70. Turning now to FIG. 41, the lever 70 is located in a forward or first position, such that the cam shaft 72 has rotated the cam 74 rotatably fixed thereto to position flat 84 to engage a cam riding surface 88B along pawls 78 such that a catch 90B collapses from the force of a biasing member 82 to engage and the teeth on the locking gear 74. In this first or forward position, the pawl 78 allows the drive arrangement 30 to operate in a forward rotation as indicated by arrows F in FIG. 41, while preventing the rotation of the entire winch assembly 10 or translation of the pulling member 18 in a direction or rotation opposite the arrows F.

When the cam 74 is rotated to the forward direction F, the opposite pawl 76 is raised by the cam, removing any locking or control over the locking gear 82. The catch 908 is constructed and designed so that the locking gear 82 will not rotate in a direction opposite the rotational direction of arrow F because the relief in the catch is not symmetrical and includes an abutment A in one direction as a lock. The catch 90B includes a sloped surface 8 opposite the abutment A to allow the rotation of the locking gear 82 from the catch through the sloped surface.

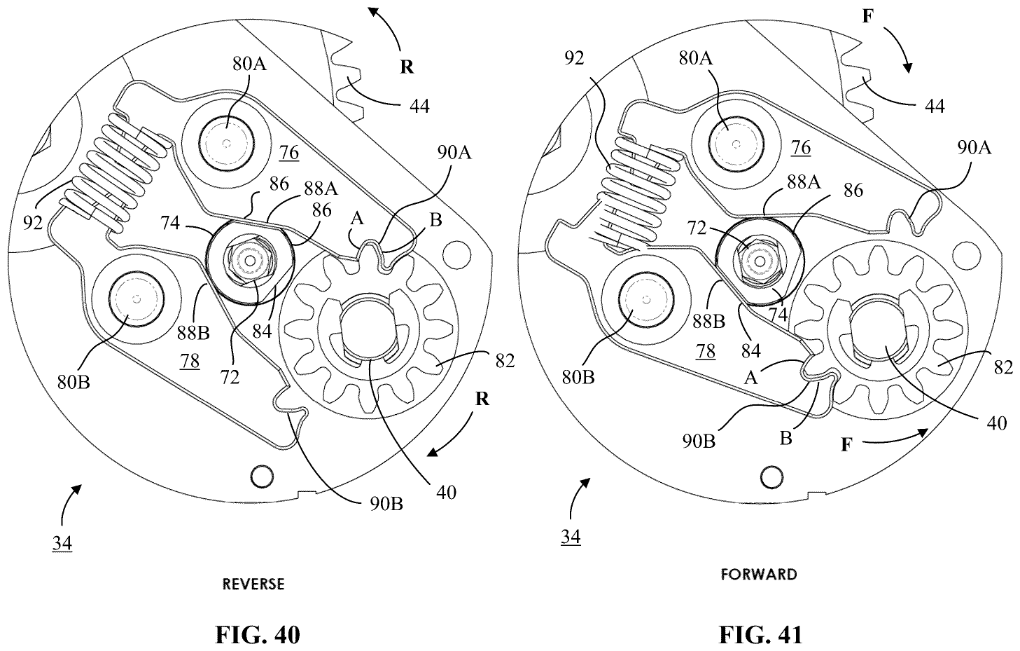

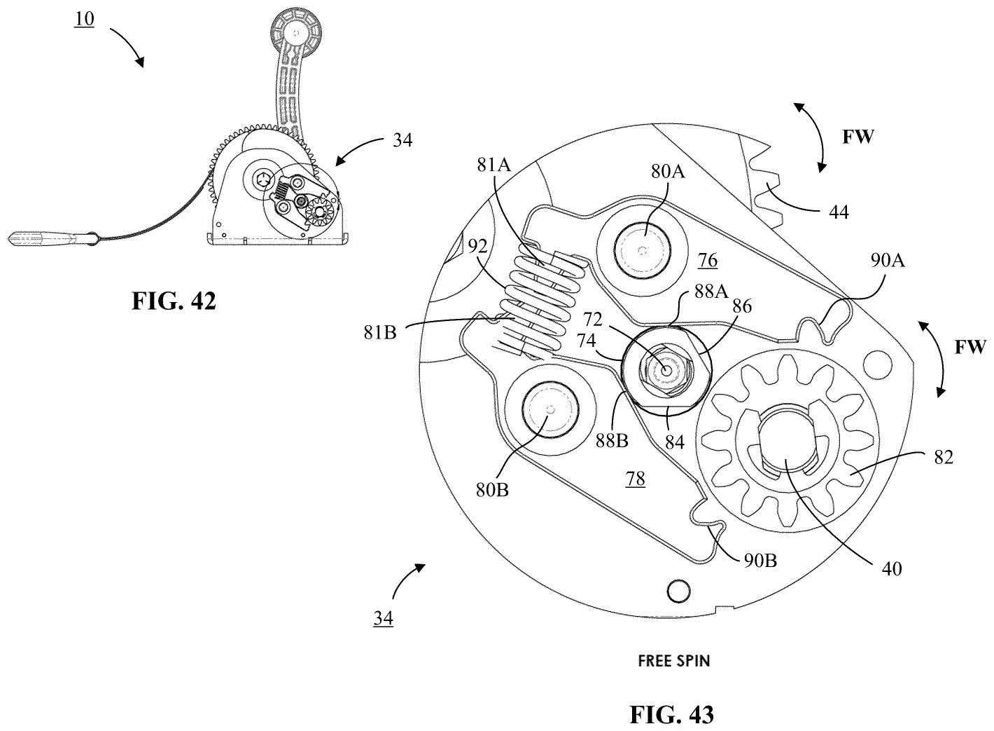

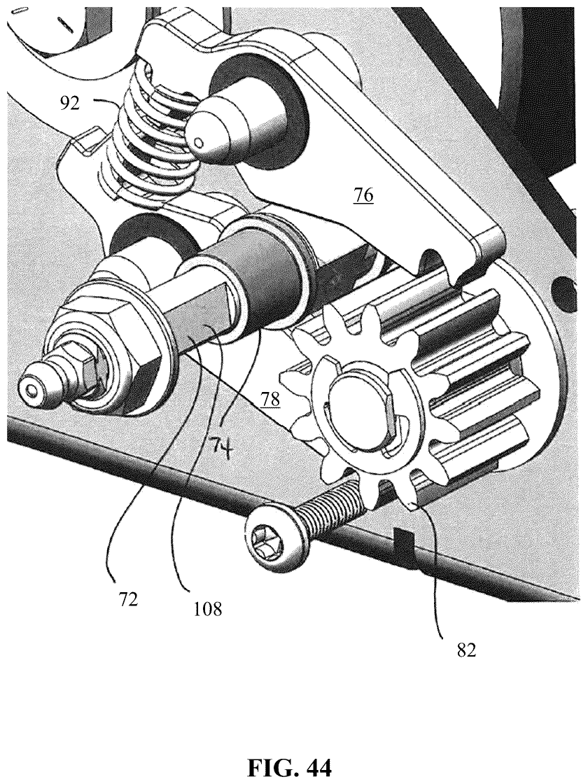

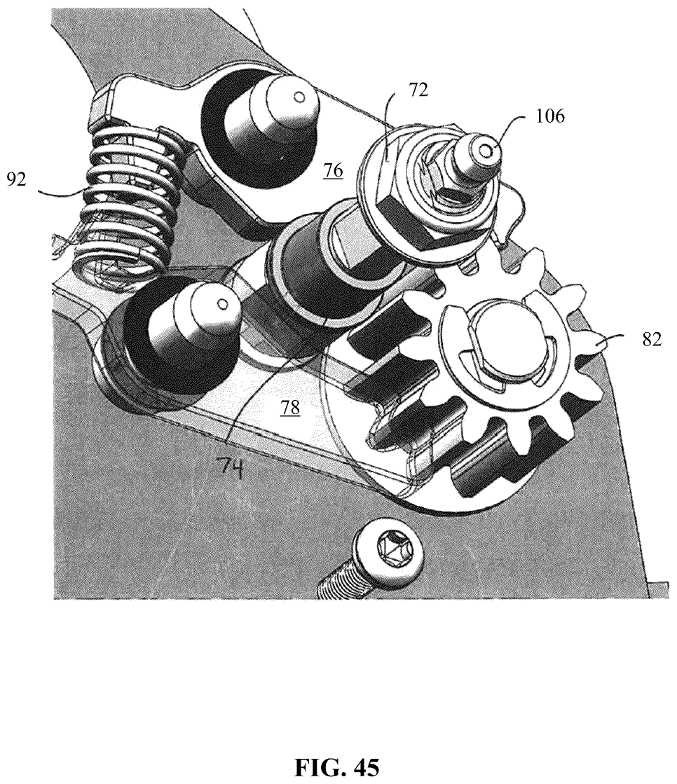

The operation assembly 34 controls the rotation of the winch assembly 10 and retraction/extraction of the pulling member through the lever 70. Turning now to FIG. 40, the lever is 70 is located in a reverse or second position, such that the cam shaft 72 has rotated the cam 74 rotatably fixed thereto to position flat 86 to engage a cam riding surface 88A along pawls 76 such that a catch 90A collapses from the force of a biasing member 82 to engage and the teeth on the locking gear 74. In this second or reverse position, the pawl 76 allows the drive arrangement 30 to operate in a reverse rotation as indicated by arrows R in FIG. 40, while preventing the rotation of the entire winch assembly 10 or translation of the pulling member 18 in a direction or rotation opposite the arrows R.

When the cam 74 is rotated to the reverse direction R, the opposite pawl 78 is raised by the cam, removing any locking or control over the locking gear 82. The catch 90A is constructed and designed so that the locking gear 82 will not rotate in a direction opposite the rotational direction of arrow R because the relief in the catch 90A is not symmetrical and includes an abutment A in one direction as a lock. The catch 90A also includes a sloped surface B opposite the abutment A to allow the rotation of the locking gear 82 from the catch through the sloped surface.

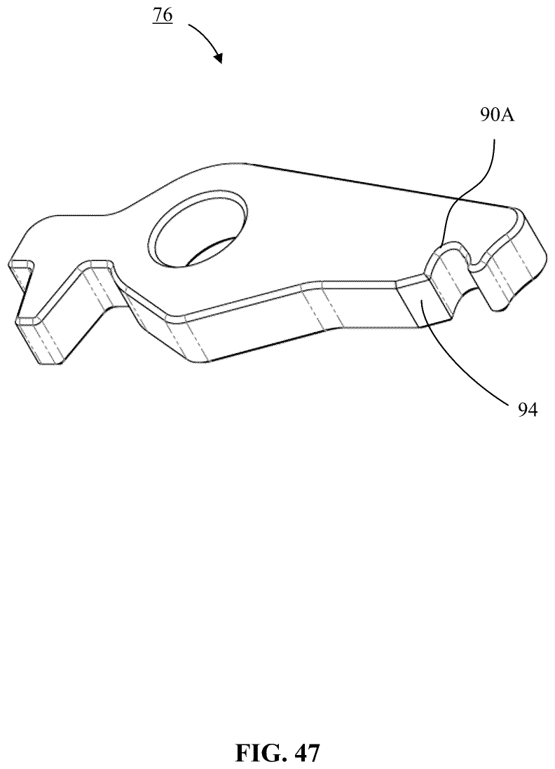

In various embodiments, the operation assembly 34 may comprise a chamfered portion 94 around catch 90A of first pawl 76 and/or catch 90B of first pawl 78. For example, FIG. 47 depicts a perspective view of an example first pawl 76 of operation assembly 34 including a chamfered portion 94 around catch 90A, according to one or more aspects described herein. In various embodiments, second pawl 78 of operation assembly 34 may similarly (or instead) include a chamfered portion 94 around catch 90B. In various embodiments, chamfered portion 94 may be located proximate to the cam 74 so as to allow easier clearance around the locking gear 82 during forward rotation F or reverse rotation R.

The operation assembly 34 controls the rotation of the winch assembly 10 and retraction/extraction of the pulling member through the lever 70. Turning now to FIG. 43, the lever is 70 is located in a free spin or third position, such that the cam shaft 72 has rotated the cam 74 rotatably fixed thereto to position round portions on the pawls 76, 78, free from contacting either flat 84, 86 to engage a cam riding surface 88A or 88B. This allows the locking gear 82 and drive gear to free spin in either rotational direction indicated by arrows FW as illustrated in FIG. 43. In the illustrated example embodiment of FIG. 11, the lever 70 is nested in a semi-circular abutment 27, such that full rotation of the lever is strategically prevented by a first end and a second end of the abutment. The abutment 27 provides a controlled travel of the lever 70, avoiding over rotation.

This double pawl 76, 78 arrangement provides a stronger directional control over the rotation of the drive gear and rotation of the spool assembly that will not rotate in a direction in which the drive gear is limited from rotation. The double pawl 76, 78 further prevents wear on the locking arrangement because the catches 90A and 90B are used on different sides of the teeth of the locking gear 82. The pawls 76 and 78 are double acting rotation about pawl shafts 80A and 80B, engaging the locking gear depending on the location of the flats 84, 86 in the cam 74.

The pawls obtain their double acting rotation by biasing member 92 that is nested over bosses 81A and 81B. In one example embodiment, the biasing member 92 is an extension spring having a spring constant between twenty (20) pounds per inch and seventy five (75) pounds per inch, and in another example embodiment a spring constant preferably at fifty (50) pounds per inch. Each pawl, 76, 78 advantageously includes double locking security by engaging the locking gear at a first contact 91A and a second contact 91B location, as illustrated in FIG. 30. The two points of contact provide an additional factor of safety against unwanted rotation of locking gear 82 and extending of the pulling member 18. Moreover, the first and second contacts 91A and 91B provide a multi-tooth engagement for better distribution of the load as the drive gear is rotated and the pulling member 18 is under tension.

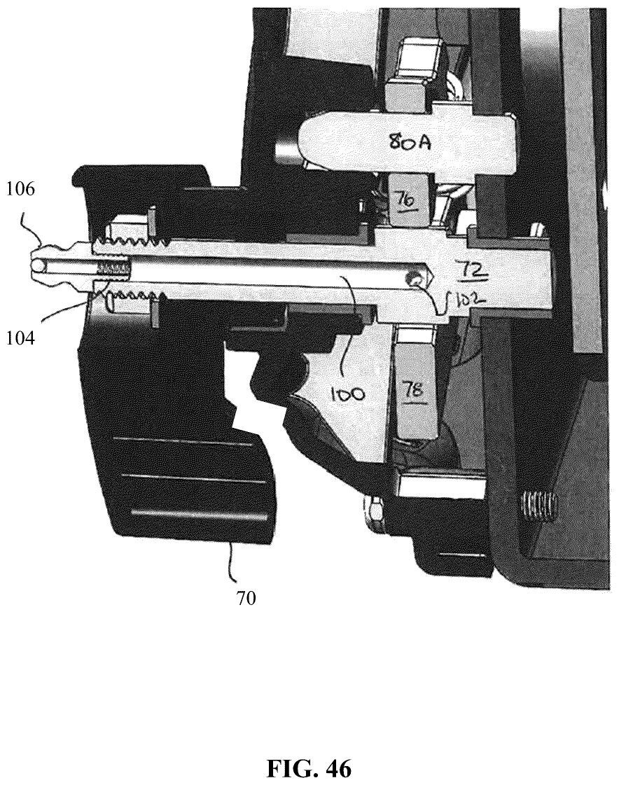

In order to allow selectable rotation of the cam 74 through the cam shaft 72, the cam shaft 72 includes a lubrication passage 100 (as depicted, for example, in FIG. 46) to an output port 102. The cam shaft 72 includes a tapped inner diameter 104 allowing the attachment of a threaded lubrication zerk 106. In the illustrated example, the cam shaft 72 includes flats for the attachment of the lever 70 in combination with a nut 110 as would be appreciated by one of ordinary skill in the art having the advantage of reading the subject disclosure and accompanying figures. The lever 70 includes a void for the projection of the zerk 106 so that lubrication, such as grease can be applied through the zerk, into the passage 100 and out one or more output ports 102 to lubricate the rotational center of the cam 74. This will prolong the life of the lever and reduce wear to the operational assembly 34.

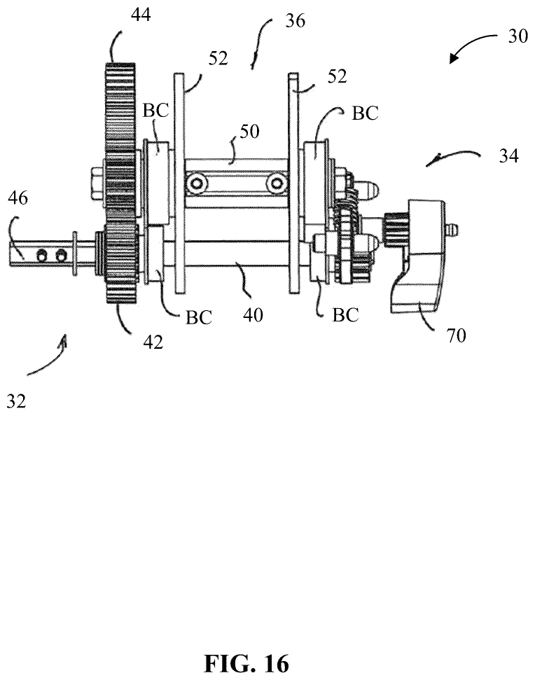

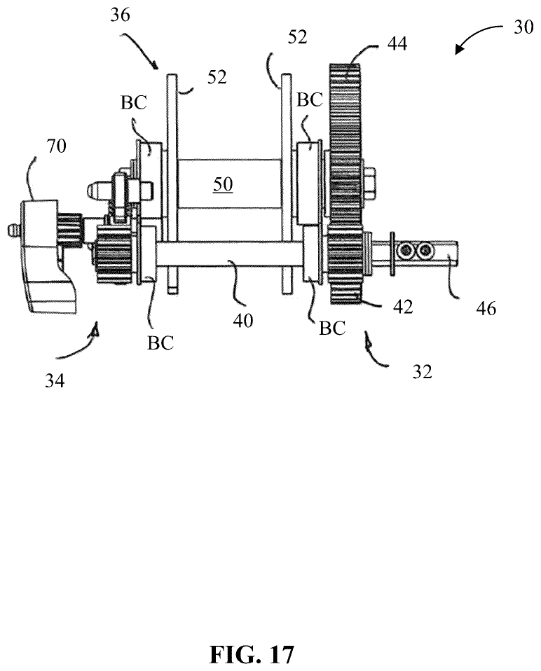

In the illustrated example embodiments, the axles 40, 50 are supported by apertures found in, for example in the housing 16 and frame 24. In one example embodiment, the support provided to the axles in the apertures is through ball bearing casings BC, facilitating a longer life for the operation of the assembly 10, as illustrated in FIGS. 16 and 17.

In the illustrated example embodiments, all the components of the assembly 10 are made from metal except for the pulling strap 18, which is made from a cloth or nylon material. However, it should be appreciated that the components of the assembly could be made from a polymeric material of similar strength, such as plastic, or any combination of metals and polymeric materials.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

An element proceeded by “comprises . . . a,” “has . . . a,” “includes . . . a,” or “contains . . . a” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A winch assembly comprising:
a drive assembly having a pinion gear and drive gear such that the pinion is coupled to a drive axle rotatably coupled to a crank arm for rotating said pinion gear, and said drive gear;
a spool assembly comprising a spool axle rotatably coupled to said drive gear, the spool axle having first and second ratchet walls for supporting a pulling member during use; and
a locking assembly comprising a locking gear that is rotatably coupled to said drive axle, said locking assembly further comprising a lever, a cam wherein said lever is rotatably coupled to said cam, and first and second pawls, such that rotation of said lever rotates said cam to a first position so that said first pawl limits the rotation of said drive axle and spool axle to a forward rotation.

2. The winch assembly of claim 1 wherein said rotation of said lever rotates said cam to a second position so that the said second pawl limits the rotation of said drive axle and spool axle to a reverse rotation.

3. The winch assembly of claim 1 wherein said rotation of said lever rotates said cam to a third position so that said drive axle and spool axle are in a free spin rotation.

4. The winch assembly of claim 1 further comprising a cam shaft for rotatably coupling said lever to said cam, wherein said cam shaft includes a lubrication passage for lubricating said cam.

5. The winch assembly of claim 1 further comprising a void located in said lever for a lubrication zerk to provide lubrication to said lubrication passage and said cam.

6. The winch assembly of claim 1 wherein said crank arm further comprises an aperture for receiving and fixedly coupling to said drive axle.

7. A winch assembly comprising:
a drive assembly having a pinion gear and drive gear such that the pinion is coupled to a drive axle rotatably coupled to a crank arm for rotating said pinion gear, and said drive gear;
a spool assembly comprising a spool axle rotatably coupled to said drive gear, the spool axle having first and second ratchet walls for supporting a pulling member during use; and
a locking assembly comprising a locking gear that is rotatably coupled to said drive axle, said locking assembly further comprising a lever, a cam wherein said lever is rotatably coupled to said cam, and first and second pawls, such that rotation of said lever rotates said cam to a first position so that said first pawl limits the rotation of said drive axle and spool axle to a forward rotation, wherein said first and second pawls each comprise a first contact and a second contact for engaging and locking multiple teeth on said locking gear.

8. A winch assembly comprising:
a drive assembly having a pinion gear and drive gear such that the pinion is coupled to a drive axle rotatably coupled to a crank arm for rotating said pinion gear, and said drive gear;
a spool assembly comprising a spool axle rotatably coupled to said drive gear, the spool axle having first and second ratchet walls for supporting a pulling member during use; and
a locking assembly comprising a locking gear that is rotatably coupled to said drive axle, said locking assembly further comprising a lever, a cam wherein said lever is rotatably coupled to said cam, and first and second pawls, such that rotation of said lever rotates said cam to a first position so that said first pawl limits the rotation of said drive axle and spool axle to a forward rotation, wherein said cam further comprises a lubrication port for lubricating an interface between said cam said first and second pawls.

9. A winch assembly comprising:
a drive assembly having a pinion gear and drive gear such that the pinion is coupled to a drive axle rotatably coupled to a crank arm for rotating said pinion gear, and said drive gear;
a spool assembly comprising a spool axle rotatably coupled to said drive gear, the spool axle having first and second ratchet walls for supporting a pulling member during use; and
a locking assembly comprising a locking gear that is rotatably coupled to said drive axle, said locking assembly further comprising a cam rotatably engaging first and second pawls, wherein said first and second pawls are rotatably biased toward said locking gear by a biasing member.

10. A winch assembly comprising:
a housing having a first side and second side for supporting a drive assembly therein;
said drive assembly having a pinion gear and drive gear such that the pinion is coupled to a drive axle rotatably coupled to a crank arm for rotating said pinion gear, and said drive gear;
a spool assembly comprising a spool axle rotatably coupled to said drive gear, the spool axle for securing a pulling member during use;
a locking assembly comprising a locking gear that is rotatably coupled to said drive axle; and
a frame assembly comprising first and second walls spaced by a base plate, said frame assembly for supporting said drive axle and said spool axle within said housing.

11. The winch assembly of claim 8 further comprising a housing for supporting said drive assembly therein, said housing comprising an abutment to limit full rotation of said lever.
